(19) United States
(12) Patent Application Publication
(10) Pub. No.: US 2003/0001724 A1
(43) Pub. Date: Jan. 2, 2003

(54) Access mechanism and engagement mechanism for a vehicle door

(76) Inventors: Robin Willats, Preston (GB); John Emson, West Midlands (GB); Sidney Fisher, West Midlands (GB); Gurbinder Kalsi, West Midlands (GB); Nigel Spurr, Solihull (GB); Jean Didier, Anould (FR); Alan Dixon, Chester (GB); Stephen Drysdale, Northampton (GB)

Correspondence Address: CARLSON, GASKEY & OLDS, P.C., 400 WEST MAPLE ROAD, SUITE 350, BIRMINGHAM, MI, 48009, US

(21) Appl. No.: 10/171,819

(22) Filed: Jun. 14, 2002

(30) Foreign Application Priority Data
Jun. 16, 2001 (GB) GB 01 14797.4
Sep. 11, 2001 (GB) GB 01 21900.5

(51) Int. Cl. G06F 7/00

(52) U.S. Cl. 340/5.72

(57) ABSTRACT

A touch sensitive access system for fitment to a vehicle and arranged such that, when touched, the means signals unlatching of a door latch of a door of said vehicle, wherein the access system is programmed only to signal unlatching once a vehicle user has ceased touching the access means.

This application claims priority to Great Britain patent application numbers GB 01 14797.4 filed Jun. 16, 2001 and GB 01 21900.5 filed Sep. 11, 2001.

### BACKGROUND OF THE INVENTION

The present invention relates to a vehicle access means and engagement means.

More particularly, the present invention relates to vehicle access means and engagement means that replace conventional exterior door handles mounted on vehicle doors.

A number of problems are associated with the use of conventional exterior door handles. Because of the necessary positioning of exterior door handles in an ergonomic position close to the upper edge of the door panel (where it easily falls to hand) and remote from the door hinge in the case of conventional vehicle passenger doors, the styling freedom of the vehicle is restricted. Additionally, positioning is restricted due to the desire for an easy connection to the vehicle latch mechanism which is usually mounted on the rear shut face of a passenger door.

Another problem with conventional handles is associated with the punching out of a hole in the outer door panel. The hole is needed to accommodate the handle, but may also crease the exterior panel thus compromising its aesthetics. Such holes may also compromise the security of the vehicle. The fact that it is difficult to fit a handle flush with the exterior door panel results in the use of handles that generate wind noise and aerodynamic drag whilst the vehicle is in motion. The use of conventional door handles also adds weight to the vehicle and adds to the number of mechanical parts.

### SUMMARY OF THE INVENTION

The present invention seeks to overcome, or at least mitigate, the problems of the prior art.

One aspect of the present invention is a touch sensitive access means fitted to a vehicle and arranged in use, when touched, to unlatch a door or said vehicle and/or facilitate the deployment of an engagement means to be engaged by a vehicle user to assist in the opening of the vehicle door.

Another aspect of the present invention is a foot operated access means fitted to a vehicle arranged in use, when actuated, to unlatch a vehicle door and/or facilitate the deployment of an engagement means to be engaged by a vehicle user to assist in operating the vehicle door.

Another third aspect of the present invention is access means for a vehicle comprising an exterior mirror, the mirror being arranged, in use, such that engagement thereof by a vehicle user unlatches a vehicle door and/or facilitates deployment of an engagement means to be engaged by a vehicle user to assist in opening the door.

Another aspect of the present invention is engagement means for engagement by a vehicle user to assist in the opening of a vehicle door, the engagement means being a handle, the handle being deployed from a retracted position, in use, in response to a signal from vehicle entry means.

### BRIEF DESCRIPTION OF THE DRAWINGS

Embodiments of the present invention will now be described, by way of example only, with reference to the accompanying drawings in which:

FIG. 1A is a perspective view of a portion of a vehicle including access means according to one embodiment of the invention;

FIG. 1B is a cross-sectional view through a vehicle door having access means according to a second embodiment of the invention;

FIG. 1C is a cutaway side elevational view through a door having access means according to a third embodiment of the invention;

FIG. 2 is a perspective view of a portion of a vehicle incorporating access means according to a fourth embodiment of the present invention;

FIG. 3 is a perspective view of a portion of a vehicle including access means according to a fifth embodiment of the present invention;

FIG. 4 is a perspective view of a portion of a vehicle including engagement means according to a sixth embodiment of the invention;

FIG. 5 is a perspective view of a portion of a vehicle including engagement means according to a seventh embodiment of the present invention; and

FIG. 6 is a schematic block diagram illustrating the interrelationship and function of an access control system incorporating access means and engagement means according to an embodiment of the present invention.

### DETAILED DESCRIPTION OF THE PREFERRED EMBODIMENT

Conventional vehicle door handles essentially serve two functions: firstly, they act as access means to unlatch the associated door and secondly as engagement means by providing a surface that a vehicle user may engage in order to open the door once unlatched. Thus, the terms “access means” and “engagement means” as used below should be understood as means whose primary function is access and engagement respectively, although the means may also perform a secondary function.

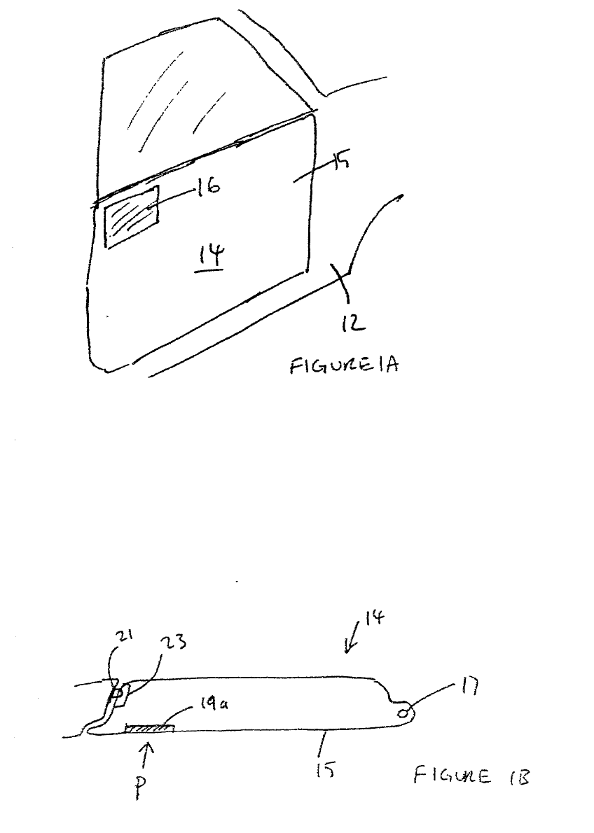

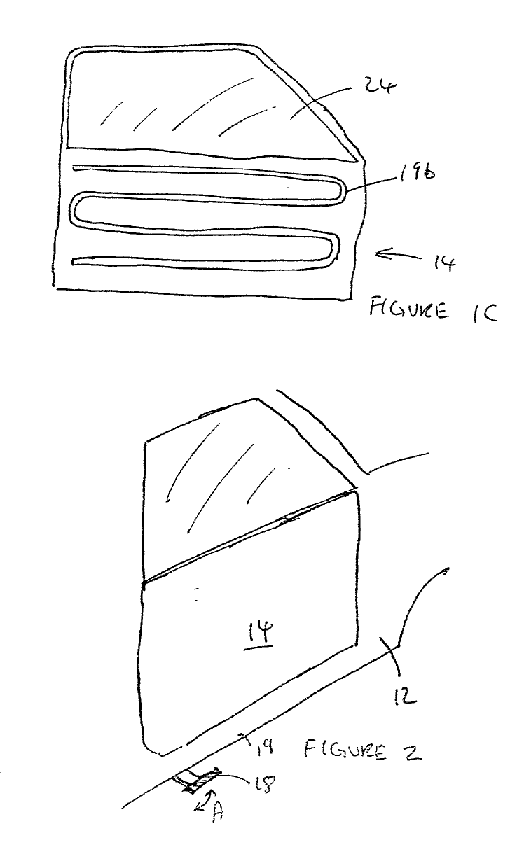

Referring to FIG. 1A there is shown a perspective view of a passenger door 14 for a vehicle 12 such as a passenger car. In place of a conventional handle that both unlatches the vehicle and provides a surface by which a vehicle user may engage the door to open it, there is provided access means that is touch sensitive which, in this embodiment, is a touch pad 16. The touch pad 16 is in turn connected to a controller 26 (see FIG. 6) and communicates therewith as described below.

Although in this embodiment, the touch pad is shown in the position of a conventional door handle, in other embodiments the touch pad 16 or other touch-sensitive means may be positioned elsewhere on the vehicle such as the passenger door window, the wing mirrors or on another vehicle panel. The touch pad 16 may be pressure sensitive or detect contact due to a change in its conductivity, but in either case there should be substantially no deflection of the surface being touched.

Turning to FIG. 1B, a strain gauge 19a is secured to the inner face of the outer skin 15 of door 14 resulting in the outer skin 15 being, in effect, the touch sensitive means. The strain gauge is in turn connected to the controller 26 and communicates therewith as described below. It can be seen that the strain gauge 19a is located in approximately the same position as touch pad 16 of the first embodiment, but because it is located on the inner face of the door skin, the door skin is uninterrupted, and does not require any apertures to be provided therein.

In use, when a user contacts the appropriate region of the door skin and exerts a pressure P. The (albeit small) deformation of the skin 15 causes the conductivity of the strain gauge 19a to change.

An alternative strain gauge arrangement is shown in FIG. 1C. In this embodiment, the gauge 19b is secured in a snaking arrangement to the inner face of the door skin 15. Thus, in this embodiment, the user may touch substantially anywhere on the door skin for detection by the strain gauge to occur.

In other embodiments strain gauges could alternatively be arranged on the door hinge 17, latch 23, striker 21 or door seal (not shown) so as to detect pressure applied to the door 14. Furthermore, force transducers may be used in place of the strain gauge. Additionally or alternatively, a strain gauge may be arranged on the window seal (not shown) to detect movement of the window glass 24 relative to the rest of the door 14, or a transparent touch sensitive sheet of the type used on computer monitors and the like could be applied to the window to enable the user to gain entry by pressing on the window glass 24.

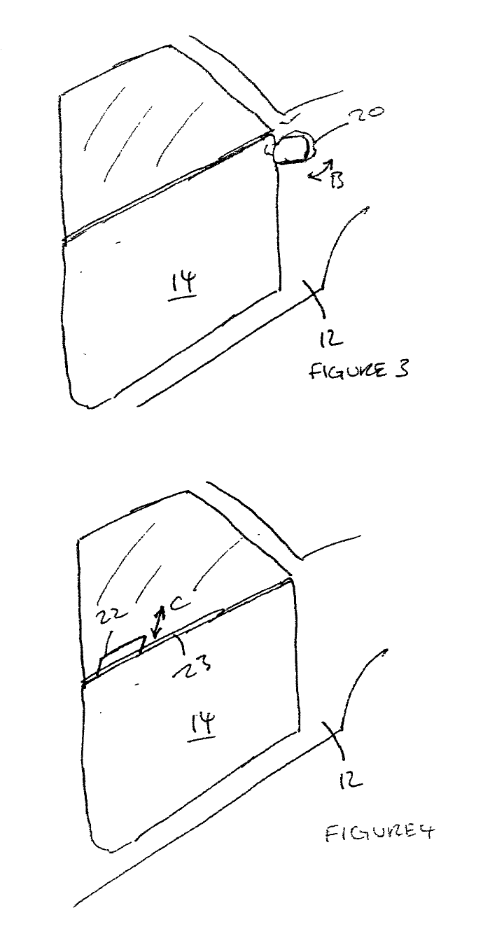

Turning to FIG. 2 there is shown a foot operated access means such as a foot operated pedal 18 mounted to the sill area 19 of a vehicle. In this embodiment, actuation of the pedal 18 in the direction A signals the controller as described in more detail below. Alternatively, the pedal 18 may be pressure sensitive, so that no actual deflection occurs. In a preferred embodiment, the pedal 18 is only deployed from a stowed position in the sill 19 when actuation thereof is required, thus preventing the fouling of the pedal 18 on foreign objects when the vehicle is in motion. One advantage of this arrangement is that the pedal 18 may be actuated when the user has no free hands.

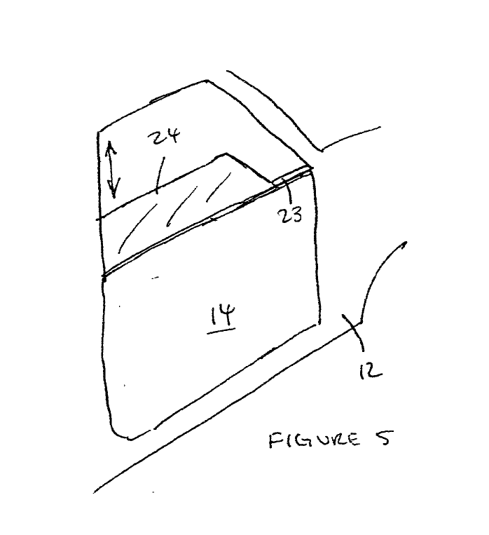

FIG. 3 illustrates a fifth embodiment of the invention in which a vehicle wing mirror 20 is used in the place of the conventional door handle as access means. In one class of embodiment, the mirror 20 may be simply be provided with a switch or touch-sensitive means similar to the first embodiment in order to signal the controller. Alternatively, where a vehicle is provided with powered mirrors, physical movement of the mirror 20 in a direction B may be converted into a signal that is sent to the controller to initiate release as described in more detail below.

Turning to FIG. 4, there is illustrated an engagement means according to a sixth embodiment of the invention. In this embodiment the engagement means comprises a deployable handle 22 that in normal circumstances is retracted within the vehicle door. However, upon a signal from a vehicle controller, the handle 22 is deployed from the “waistline” (the sill portion where the door panel meets the window) 23 of the vehicle. In one embodiment, the handle 22 is merely provided as a convenient surface that a vehicle user may engage to open the door 14. However, in variant form, the handle 22 may also be operably connected to the vehicle latch such that engagement thereof causes the door to become unlatched. The interaction of the handle 22 and the controller is described in more detail below.

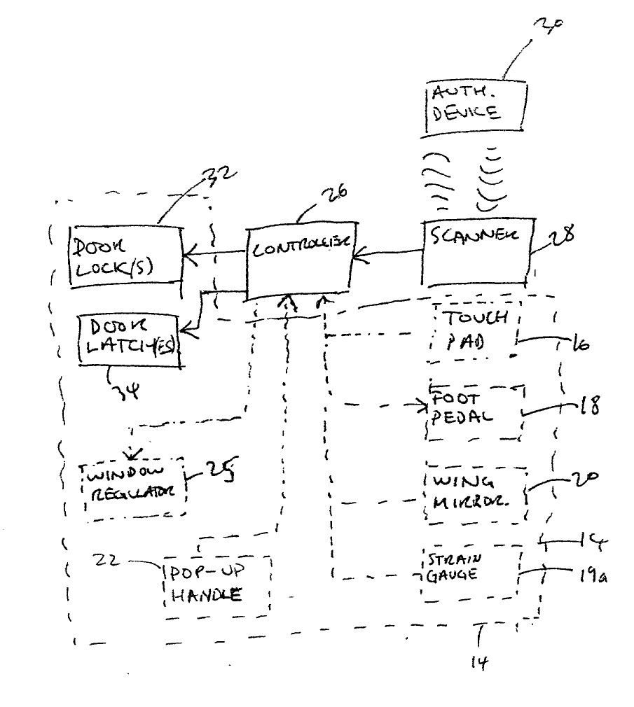

The engagement means according to a seventh embodiment of the invention is shown in FIG. 5. In this embodiment the engagement means is provided by the window sill 23 of the door 14. Clearly, for reasons of security, the door window 24 will usually be left in a closed position when the vehicle is left unattended. However, when a signal is received from the controller as described in more detail below, this causes the window regulator (25, FIG. 6) to lower the window glass 24 and thus enable a vehicle user to grasp the sill or top of the window glass and open the door.

Turning now to FIG. 6 in which an overall access control system incorporating various aspects of the present invention is shown in schematic form. It can be seen that at the heart of the system is the controller 26. The controller 26 is preferably in the form of a microprocessor and may be a stand-alone controller for access control or may be integrated into an overall controller for a number of vehicle functions.

As shown in FIG. 6, an authorization device 30 in the form of a transponder is carried by a vehicle user. When the user walks into range of a scanner 28 associated with the vehicle, the scanner 28 interrogates the authorization device 30 using radio frequency or other electromagnetic waves and the like in order to determine whether that particular authorization device 30 permits access to the vehicle 12. If access is permitted, the scanner 28 signals the controller 26 to unlock electrically operable door lock 32 and in certain classes of embodiment to also unlatch electrically operable door latches 34.

In installations where the authorization device 30 causes just the unlocking of the door locks 32, the user then actuates either touch pad 16, door skin 15, window 24 or wing mirror 20 by hand or foot pedal 18 by foot (the various alternative means being illustrated by broken lines in FIG. 6). Actuating the relevant access means signals the controller 26 which in turn signals the unlatching of door latches 34. The controller 26 preferably also signals the deployment of either handle 22 (if fitted) or the window regulator 25 to drop the window glass 24 so that a surface is available for the user to engage by hand and open the door 14. In its simplest form, however, specific engagement means may be dispensed with because the force exerted on the door by the door seals (not shown) is generally sufficient to cause the door to open enough when the door is unlatched for a user to engage an edge of the door by hand and open it. In some cases of embodiment the door hinge and/or door check may also exert an outward force that tends to cause the door to open.

In a preferred embodiment, when a touch pad 16 or strain gauge 19a, 19b is used as an access means and is mounted on the door 14, the controller 26 only signals the unlatching of the door once the user ceases to touch the touch pad 16, door skin or window. This avoids the possibility of the force due to contact between the user's hand and the touch pad, door skin or window counteracting the seal force and preventing the door opening by a sufficient amount, and also substantially avoids the risk of user discomfort being caused by the door opening against their fingers.

If the vehicle is fitted with a foot pedal 18, the signal from the scanner 28 to the controller 26 preferably causes the controller 26 to signal the lowering of the foot pedal 18 from a retracted position in the sill to a deployed position where it may be actuated by the foot of the vehicle user.

In embodiments where the controller 26 signals the unlatching of the door latch 34 in response to signals from the scanner 28, the access means may be dispensed with. Similarly, in embodiments where the handle 22 is operably connected to the latch(es) 34, the access means may be dispensed with.

Once the vehicle user has entered the vehicle and closed the door, the controller 26 signals the retraction of the pop-up handle 22 and/or of pedal 18 as appropriate, or signals the closure of the window 24. Optionally, a vehicle motion detector (not shown) may be connected to the controller 26 such that the controller 26 may signal the locking of door locks 32 if the vehicle exceeds a certain predetermined speed such as 5 kilometers per hour, for example.

To summarize, the access means of FIGS. 1A to 3 may operate separately or in conjunction with the engagement means of FIGS. 4 and 5. Likewise, the engagement means of FIGS. 4 and 5 may operate separately from the access means of FIGS. 1 and 3.

It should be understood that numerous changes may be made within the scope of the present invention. For example, the system may be adapted for use with other vehicle doors such as sliding doors or rear doors and alternative types of scanner such as sonar, ultrasonic or infra-red type scanners may be used in place of a radio frequency scanner. The invention may be adapted for use with conventional remote keyless entry (RKE) “plip”-type locking devices rather than a passive entry system. Furthermore, touch sensitive means such as strain gauges may be employed as exit means on the inside of doors to permit exit from as well as entry to vehicles. Likewise, the engagement means described above may be deployed from the interior of the vehicle to assist in closing vehicle doors.

The foregoing description is only exemplary of the principles of the invention. Many modifications and variations of the present invention are possible in light of the above teachings. The preferred examples of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A touch sensitive access system for fitment to a vehicle and arranged such that, when touched, the access system signals unlatching of a door latch of a door of the vehicle, wherein the access system is programmed to signal unlatching once a vehicle user has ceased touching the access system.

2. The access system according to claim 1 wherein the access system is a touch pad.

3. The access system according to claim 1 wherein the access system is provided on the vehicle door.

4. The access system according to claim 3 wherein the access system is located proximate an upper edge of a door skin of the door.

5. The access system according to claim 4 wherein a strain gauge positioned on an inner face of the door skin detects touch.

6. The access system according to claim 4 wherein a strain gauge fitted to at least one of a hinge, a latch, a striker, and a seal of a door incorporating the door skin detects touch.

7. The access system according to claim 1 wherein the access system is provided on a vehicle mirror.

8. The access system according to claim 1 wherein a strain gauge associated with a window detects touch.

9. The access system according to claim 1 wherein the access system further signals deployment of an engagement system arranged to be engageable by a vehicle user to assist in the opening and closing of the vehicle door.

10. An access system arranged such that, when actuated, the access system signals unlatching of a vehicle door latch and signals deployment of an engagement system arranged to be engageable by a vehicle user to assist in opening and closing the vehicle door.

11. The access system according to claim 10 wherein the access system is a foot operated pedal fitted to a vehicle.

12. The access system according to claim 11 wherein the access system is locatable in a sill area of the vehicle.

13. The access system according to claim 11 wherein the access system is operably connected to a passive entry system and the access system is moved from a retracted position to a deployed position when the passive entry system signals the unlocking of the vehicle door.

14. The access system according to claim 11 further comprising a controller arranged to receive signals from the access system and control operation of the door latch.

15. The access system according to claim 10 wherein the access system is an exterior mirror arranged such engagement thereof by a vehicle user signals unlatching of the vehicle door latch.

16. The access system according to claim 15 wherein a touch sensitive device is provided on the mirror to detect engagement thereof by a vehicle user.

17. The access system according to claim 15 wherein physical movement of the mirror is detectable to indicate engagement thereof by a vehicle user.

18. The access system according to claim 15 further comprising a controller the controller being arranged to receive signals from the access system and control operation of the door latch and a passive entry system.

19. An engagement system for engagement by a vehicle user to assist in the opening and closing of a vehicle door, the engagement system being retractable in response to a signal from a vehicle entry system.

20. The engagement system as recited in claim 19 wherein the engagement system is a handle deployable from a waist-line area of the vehicle door.

21. The engagement system as recited in claim 19 wherein a window pane portion of the vehicle door is retractable in response to said signal from said vehicle entry system to permit engagement.

22. The engagement system according to claim 19 wherein the vehicle entry system comprises a passive entry system.

23. The engagement system according to claim 19 wherein the vehicle entry system includes at least one of a touch sensitive access system, a foot operated access system and a vehicle exterior mirror access system having an input.
